(19) United States
(12) Patent Application Publication
(10) Pub. No.: US 2019/0185294 A1
(43) Pub. Date: Jun. 20, 2019

(54) METHOD FOR MANUFACTURING A PLATFORM LIFT RAIL

(71) Applicants: THYSSENKRUPP HOME SOLUTIONS S.R.L., Pisa (IT); thyssenkrupp AG, Essen (DE)

(72) Inventor: Fabio SBRANA, Cascina Pisa (IT)

(73) Assignees: THYSSENKRUPP HOME SOLUTIONS S.R.L., Pisa (IT); thyssenkrupp AG, Essen (DE)

(21) Appl. No.: 16/327,936

(22) PCT Filed: Aug. 14, 2017
(86) PCT No.: PCT/EP2017/070603

§ 371 Date: Feb. 25, 2019

(30) Foreign Application Priority Data
Aug. 26, 2016 (EP) 16185957.4

(51) Int. Cl. B66B 9/08; B21D 47/01

(52) U.S. Cl. CPC B66B 9/0846; B21D 47/01; B66B 9/0815

(57) ABSTRACT

A method of manufacturing a platform lift rail having a curved direction of travel. The platform lift includes a rail and a drive unit configured to drive along the rail. The rail includes a tubular section for supporting the drive unit and a rack section adapted for positively engaging with driving means of the drive unit. The method includes providing a metal sheet, plastic forming, in a first forming step, the metal sheet into a tubular profile, closing the tubular profile and forming a projecting flange by connecting opposite faces of the metal sheet, permanently fixing the flange by joining the opposite faces in the area of the projecting flange, creating positive engagement means into the projecting flange, and plastic forming, in a second forming step, the metal sheet to provide the rail with a curved direction of travel.

### TECHNICAL FIELD

The invention refers to a method for manufacturing a platform lift rail, a platform lift rail and a platform lift having such a rail.

### TECHNICAL BACKGROUND

EP 1 554 210 Aldiscloses a platform lift for the use of a disabled person in a wheelchair. WO 2013/129923 A1 discloses a platform lift in the form of a stairlift. In both cases the platform is part of a drive unit which travels along at least one guide rail. A leveling mechanism is provided to hold the platform always in a horizontal orientation, even if the inclination angle of the guide rail is changing along the path of travel.

The invention refers in particular to the rail of such platform lifts, in which the rail has curved shape, like shown in FIG. 3 of WO 2015/052489 A1. Conventionally the tube shaped rails are manufactured by a prefabricated tube, to which a separate rack is welded. This requires separate bending processes for preparing the tube and the rack as well as a joining process of the complex shaped tube and rack. This kind of platform lift rail and the respective welding process is shown in the brochure “Dit is uw thuis—Swing, de traplift geschikt voor alle trappen”, ThyssenKrupp Encase NV, 2016.

### DISCLOSURE OF THE INVENTION

It is an object of the invention to provide an alternative method for manufacturing a rail of the aforementioned kind. This object is solved by a method, a platform lift rail and a platform lift according to the main claims. Preferred embodiments are described in the subclaims and the description.

According to the invention the method comprising: providing a sheet metal, plastic forming the sheet metal so as to form a tubular profile, thereby closing the tubular profile, and forming a projecting flange, in particular by connecting opposite faces of the sheet, permanently fixing the flange, in particular by joining the opposite faces in the area of the projecting flange, creating positive engagement means into the projecting flange.

With this method it is possible to obtain a rail including the rack in one piece without any necessity to add materials by additional joining process. The rail can be manufactured using several kinds of material, as conventional steel, stainless steel, zincked steel, and others ductile/moldable materials. The inventive method enables advantages with regard to cost and stability, at the same time using a very simple primary material.

The platform lift, for which the invention is applicable, comprises at least one rail and a driving unit adapted for driving along the rail. The invention is in particular applicable for a single rail platform lift, which requires exactly one rail for guiding the drive unit. Also the invention is applicable to a double rail platform lift, which in particular requires exactly two rails running in main parallel to each other. The invention is particularly applicable to rails, which deviate from a straight lined shape, thus wherein the direction of travel is curved. “Curved” means in this regard “not straight lined”. The term “plastic forming” means particular manufacturing processes, which make use of suitable stresses to cause plastic deformation of the materials to create a desired shape. The applied manufacturing processes are in particular bending, high pressure forming, rolling.

The material defining the rail is in particular solely provided by sheet metal. No other material is then necessary to be joined to the sheet, except material for surface treatment, like color or anticorrosive coatings. To obtain sufficient stability the thickness of the sheet material may be increased or the shape of the tubular section may be selected to support the loads applied to the rail.

In a second step of plastic forming the rail is provided with a curved travel direction. Here the rail can freely be shaped according to the spatial needs defined by the installation situation at the stairway. Nearly every configuration may be possible due to the formability of the sheet metal. Thereby during the second step of bending the cross section of the tubular profile is preferably maintained. Small deviations of the cross section during the course of the rail may be covered by the term “maintained”, which still allow, that the drive unit is able to drive along the entire rail.

Preferably an enforcement bracket is inserted into the flange, in particular between the opposite faces to be connected. This may selectively increase the stability of the rack section, without the need to use much thicker sheet metal at the tubular section.

Preferably during first plastic forming the opposite faces of the sheet metal come to rest on each other with the same surface. This enables to create the flange easily.

The inventive rail is characterized in that at least parts of the rack section and at least parts of the tubular section are made from one piece, in particular from the same sheet metal. Preferably at least parts of the positive engagement means and at least parts of the tubular section are made from one piece, in particular from the same sheet metal.

The described advantages and embodiments regarding the method are applicable to the inventive rail and vice versa.

### BRIEF DESCRIPTION OF THE DRAWINGS

The invention is explained in more detail with the help of the figures, the figures show:

FIG. 1 a) a generic platform lift in a first embodiment,

b) a generic platform lift in a second embodiment,

c) a generic platform lift in a third embodiment;

FIG. 2 a conventional rail for a generic platform lift;

FIGS. 3-9 illustrations of the method steps to manufacture an inventive rail out of a sheet metal;

FIGS. 10, 11 alternative steps to the steps of FIGS. 4 and 5;

FIG. 12 an inventive rail having an alternative shape.

### DESCRIPTION OF AN INVENTIVE EMBODIMENT

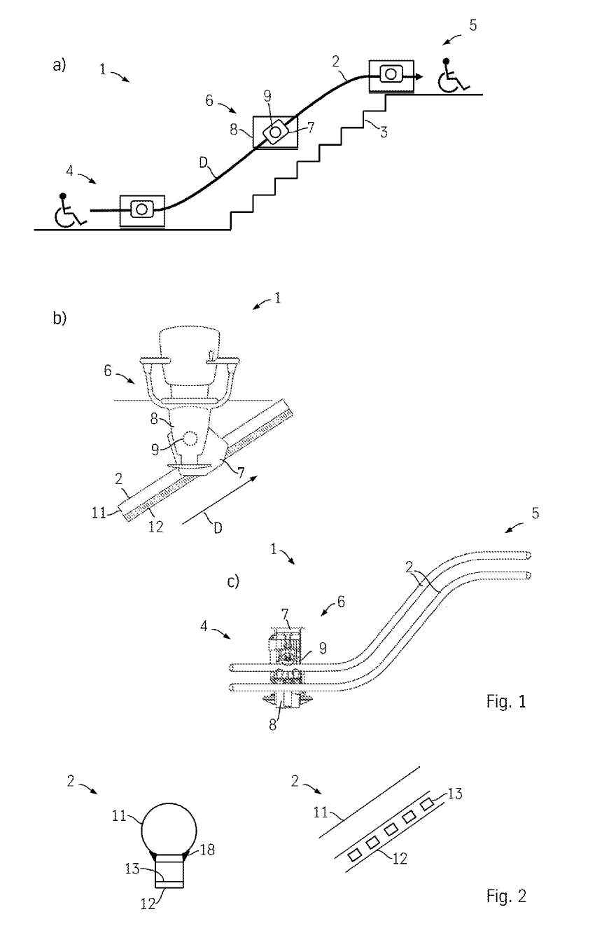

FIG. 1 shows three exemplary embodiments of a generic platform lifts 1, to which the invention can be applied. In figure la a platform lift 1 for the use with a wheelchair is shown. The platform 8 therefore comprises a kind of lifting ramp, which can travel along a direction of travel D from a first lading area 4 to a second landing area 5. The direction of travel D is defined by a rail 2, and is driven in main by the course of an existing stairway 3 in a house. An alternative embodiment is shown in figure lb wherein the platform 8 comprises a seat.

The rail of the platform has in particular a curved shape, which deviates from a straight line; thus the direction of travel will change at least once during the course of the rail 2.

The platform 8 is part of a driving unit 6, which further comprises a carrier 7. The carrier has non shown rollers, which roll along the rail 2. For driving the carrier positive engagements means 13 (only shown in detail in figure lb) are provided on the rail 2, which cooperates with driving means, in particular a driven pinion (not shown), of the carrier 6. A leveling mechanism 9 is provided on the drive unit, to keep the platform 6 always in a horizontal orientation, even if the inclination of the rail 2 varies during its course.

Figure lc shows a platform lift in main similar to the lift of figure la. The lift comprises two rails, which are arranged in main parallel to each other. The distance of the two (in main parallel) rails is varying during the course of travel; this variation of the distance may be the input value of the leveling mechanism.

FIG. 2 shows a conventional rail (cross section and side view). The rail 2 comprises a tube 11 and a rack 12. The rack 12 is joined to the tube e.g. by welding or gluing (see exemplary weld seam 18). The rack 12 comprises said engagement means 13.

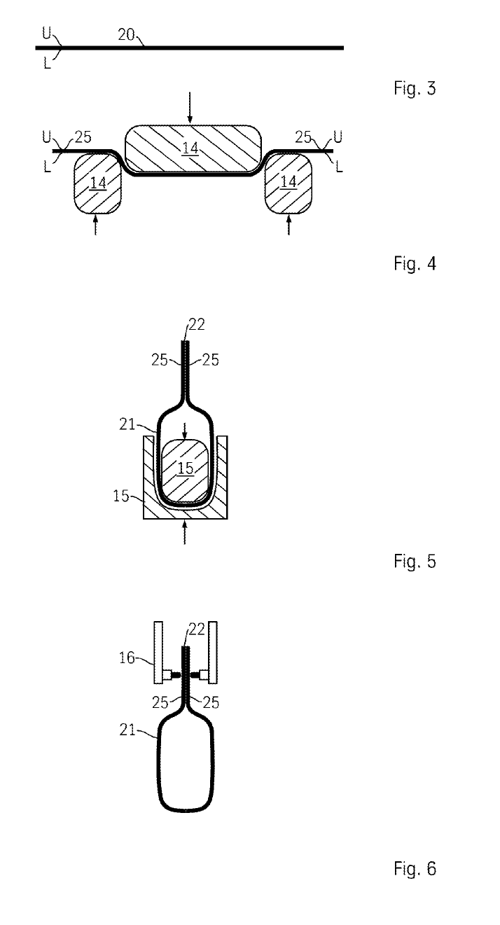

FIG. 3 shows a sheet metal 20, out of which a rail 2 suitable for the platform lifts 1 of figure la and lb is manufactured.

In a first bending step (FIGS. 4 and 5) a tubular profile 21 is created out of a central area of the sheet metal 20. Two faces 25 of the sheet metal 20 are bend in way, so that the faces 25 abuts each other at the same upper surface U of the sheet metal 20. The lower surface L of the sheet metal forms the outer surface in all areas of the cross section of the bent sheet metal 20.

Consequently, the two faces 25 form a projecting flange 22, which projects radially from the tubular section 21. The term “radially” is in this context to be understand broadly. As evident from FIG. 5 the term radially does not need a geometrical exact circle, to which it refers.

Additionally FIG. 12 shows an alternative cross section; here the projecting flange 22 is oriented out of square regarding an imaginary center axis 26 of the profile. So the term radially projecting, roughly speaking, means that the flange points away from the tubular section 21.

As an example the first plastic forming step comprises two bending substeps, which are illustrated in FIGS. 4 and 5, each using a bending apparatus 14, 15; nevertheless, any other suitable kind of forming process may be used within these substeps, in particular high pressure forming, rolling, etc.

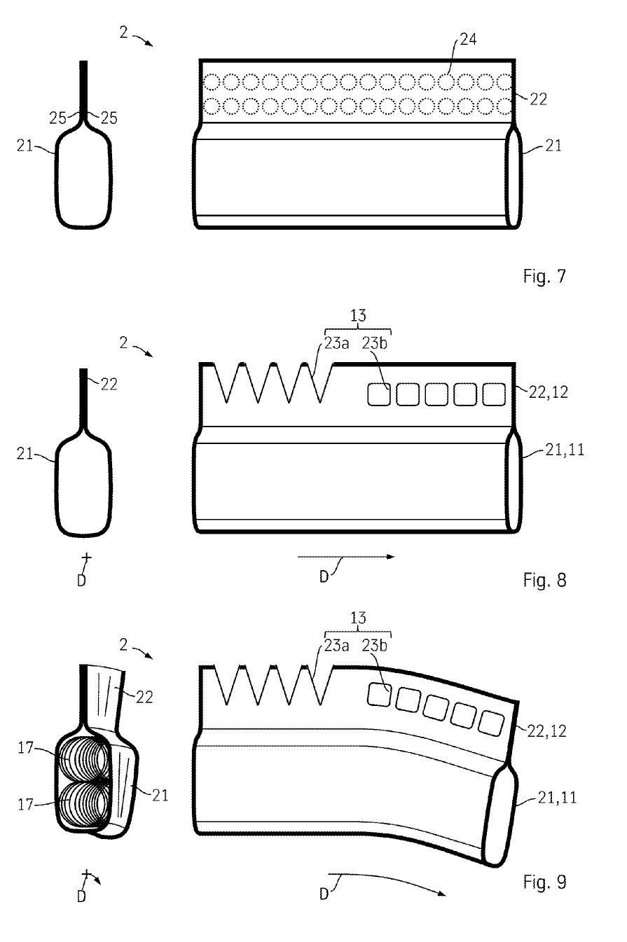

Subsequently, the faces 22 are permanently fixed to each other, in this embodiment by spot welding, using a spot welding apparatus 16. FIG. 7 shows the resulting rail 2 comprising a number of welds spots 24.

In a subsequent step the positive engagement means 13 are introduced into the flange. Here in particular a material removing process is suitable, in particular laser cutting, machining (e.g. milling), etc.

Different kind of positive engagement means 13 can be produced; exemplary in FIG. 8 on the left side a notch 23a and on the right side a rectangular hole 23 is shown, merely for illustration purposes. In particular by laser cutting, nearly every form can be produced.

For most stairway applications the rail 2 needs to be adapted to an individual curvature of the stairway. The rail 2 of FIG. 8 is subsequently (FIG. 9) bent in a second plastic forming step, to adapt the rail to the desired course of the travel direction. For this second plastic forming step several processes can be used: e.g. using a mold with two pieces, each one defining the complementary shape of the final shape of the rail, without the needs a the mandrel inside.

Alternatively it is possible to bend only with a simple mold, by using with a rigid, semi-rigid or flexible mandrel.

As obvious from FIG. 9, during the second forming step the cross section of the tubular section not changed, disregarding any minor deviation in the cross-section technically caused by the forming. If necessary a mandrel 17 can be placed within the tubular profile 21 to prevent the tubular profile from being chewed.

As a mandrel 17 a coil spring may be used; the advantage is that this kind of mandrel can be pulled out of the tubular profile 21, after the tubular profile 21 is formed into a curved shape during the second plastic forming step. In this particular embodiment shown in the figures, the tubular profile 21 has a shape which deviates from a circular cross-section more into a rectangular cross section; here the use of two mandrels 17 is advantageous, which together reproduce in main the cross-section of the tubular section 21.

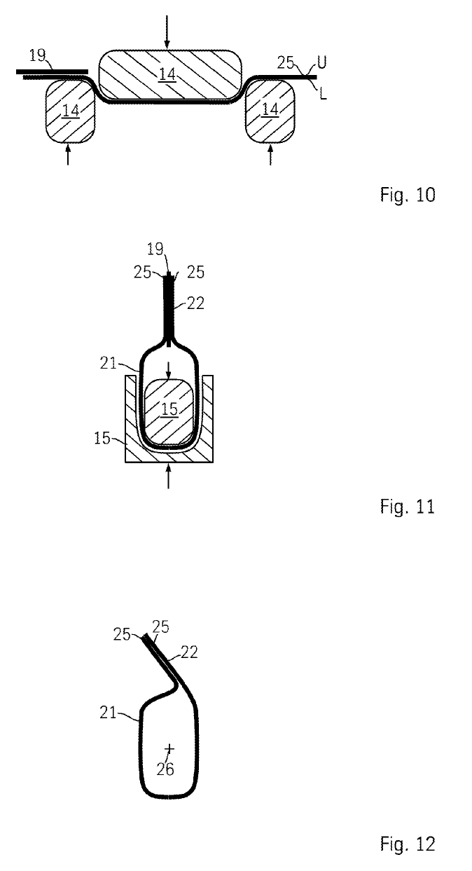

FIG. 10 shows an improvement of the aforementioned method. Prior to permanently fixing the faces 25 to each other, a reinforcement bracket 19 is put between the faces 25. During welding the bracket 19 is also permanently fixed between the two faces 25, which are now indirectly connected to each other (FIG. 11), thus improving the stability of the flange 22.

FIG. 12 illustrates, that by the inventive method rails of various cross-sections can be created, which is only limited by general restrictions of the respective forming method.

Even if the preferred embodiment is described my means of a bending step for the plastic forming, the advantages and embodiments described here a re also applicable to any other plastic forming process.

### LIST OF REFERENCE SIGNS

1 platform lift

2 platform lift rail

3 stairway

4 first landing area

5 second landing area

6 drive unit

7 carrier

8 platform

9 balancing system

11 tubular section

12 rack section

13 engagement means

14 first bending apparatus

15 second bending apparatus

16 welding apparatus

17 mandrel (spiral spring)

18 weld seam

19 enforcement bracket

20 sheet metal

22 hollow profile

22 projecting flange

23a notch

23b hole

24 weld spot

25 opposite faces

26 imaginary center axis

D travel direction

U Upper surface of sheet metal

I lower surface of sheet metal

1.-7. (canceled)

8. A method of manufacturing a platform lift rail having a curved direction of travel, the platform lift comprising a rail and a drive unit configured to drive along the rail, the rail comprising a tubular section for supporting the drive unit, and a rack section adapted for positively engaging with driving means of the drive unit, the method comprising:
providing a metal sheet,
plastic forming, in a first forming step, the metal sheet into a tubular profile;
closing the tubular profile and forming a projecting flange by connecting opposite faces of the metal sheet;
permanently fixing the flange by joining the opposite faces in the area of the projecting flange;
creating positive engagement means into the projecting flange; and
plastic forming, in a second forming step, the metal sheet to provide the rail with a curved direction of travel.

9. The method of claim 8, comprising:
maintaining the cross section of the tubular profile during the second forming step.

10. The method of claim 8, comprising:
inserting an enforcement bracket into the flange between the opposite faces to be connected.

11. The method of claim 8, wherein during bending the opposite faces of the metal sheet are brought to rest on each other with the same surface.

12. A platform lift rail having a curved direction of travel, the platform lift having a rail and a drive unit driving along the rail, the rail comprising,
a tubular, hollow section configured to support the drive unit,
a rack section having positive engagement means configured to positively engage with driving means of the drive unit, the positive engagement means radially extending from the tubular section, and
at least parts of the rack section and at least parts of the tubular section being made from the same piece of sheet metal.

13. The platform lift rail according to claim 12, wherein at least parts of the positive engagement means being made from the same piece of the metal sheet.

14. A platform lift comprising the platform lift rail of claim 12.

15. A platform lift comprising the platform lift rail according to the method of claim 8.
